(19) United States
(12) Patent Application Publication
(10) Pub. No.: US 2003/0200095 A1
(43) Pub. Date: Oct. 23, 2003

(54) Method for presenting text information with speech utilizing information processing apparatus

(76) Inventor: Shen Yu Wu, Taipei (TW)

Correspondence Address: JACOBSON HOLMAN PLLC, 400 SEVENTH STREET N.W., SUITE 600, WASHINGTON, DC, 20004, US

(21) Appl. No.: 10/127,421

(22) Filed: Apr. 23, 2002

(51) Int. Cl. G10L 21/00

(52) U.S. Cl. 704/275

(57) ABSTRACT

A method for presenting text information with speech according to the invention applies an information-processing apparatus in which a speech database is included. The text information is transformed into speech information according to the speech database, and turned into speech and played. The text information can also be downloaded from a network so that the text information can be online accessed and played with speech.

### BACKGROUND OF THE INVENTION

1. Field of the Invention

The invention generally relates to an information presenting method, and particularly relates to a method for presenting text information with speech through an information-processing apparatus.

2. Related Art

Recently, information can be downloaded and read in electronic manners through the Internet. For example, electronic books are stored in digital format with some media, such as optical discs, IC memory cards, flash memories or websevers. The electronic files can be read through electronic devices, such as portable computers, WAP cellular phones, GPRS phones or even the newest 3G phones. Since the electronic books are digital information that require only storage media, they have advantages of powerful function, for example, low cost, easy access and portability.

With the aforesaid advantages, electronic books have been fast developed. The contents and formats of electronic books become versatile. As the electronic books are developed with similar concepts of traditional books, most electronic books include a majority of text and parts of sound, images, animations, network activities, interaction or information searching.

In other words, the current electronic books are mainly presented with static texts. In view of the possibilities of electronic books, electronic books should present more styles than common texts. For example, speech is a good manner of presentation. Especially when information is displayed on a personal digital assistant (PDA), the limited area of the display of PDA makes text-reading difficult. Therefore, a speech method for the text information is more practical for overcoming the display limitation.

### SUMMARY OF THE INVENTION

The object of the invention is to provide a method for presenting text information with speech utilizing an information-processing apparatus. The method turns text information into speech so that a user can read and listen the information when the information-processing apparatus displays and speaks the text contents.

A method for presenting text information with speech according to the invention applies an information-processing apparatus in which a speech database is included. The method includes the following steps. First, selecting the text information. Then, inputting a speech playing command. Instructing the user to choose a portion of the text information that is to be read. Then, selecting the designated text portion and transforming into speech information by means of the speech database. And finally, outputting speech of the speech information.

In the aforesaid steps, after the step of inputting a speech playing command, a step of selecting speech tone is also included. The speech tone includes male voice and female voice.

When the information is stored on a network, the process will start first from linking to the network and downloading the information.

As for the kind of information, they can be electronic books or others. The information-processing apparatus can be a personal digital assistant, a mobile communication device, or a portable computer.

### BRIEF DESCRIPTION OF THE DRAWINGS

The invention will become more fully understood from the detailed description given hereinbelow. However, this description is for purposes of illustration only, and thus is not limitation of the invention, wherein:

FIG. 1 is a block diagram of an information-processing apparatus applying the invention;

FIG. 2 is a flowchart showing a first embodiment of the invention; and

FIG. 3 is a flowchart showing a second embodiment of the invention.

### DETAILED DESCRIPTION OF THE INVENTION

The invention provides a method for presenting text information with speech on an information-processing apparatus. The information-processing apparatus can be a personal digital assistant, a mobile communication device, or a portable computer. The following description takes a personal digital assistant as an example, and the text information is of an electronic book.

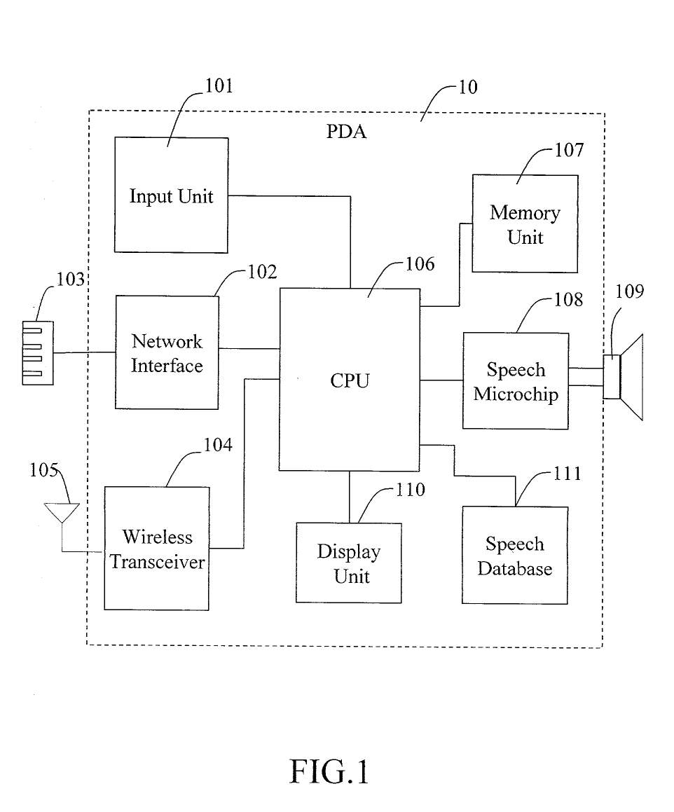

As shown in FIG. 1, a personal digital assistant 10 is composed of an input unit 101, a network interface 102, a network connector 103, a wireless transceiver 104, an antenna 105, a central processing unit 106, a memory unit 107, a speech microchip 108, a speaker 109, a display unit 111 and a speech database 111.

The input unit 101 is used for input of user's commands. It usually includes a touch panel and some basic keys. The network interface 102 and the network connector 103 are used to connect with a network, such as Internet. The wireless transceiver 104 and the antenna 105 are used for wireless communication or wireless connection to the Internet. The central processing unit 106 controls the whole operation. The memory unit 107 generally includes read-only memories for storing information of the operation system, and recordable memories for storing application software and data. There may also be a slot for mounting a memory card (not shown in the drawing) for expansion of memories. The speech microchip 108 transforms the digital information processed by the central processing unit 106 into analog signals. The analog signals generate speech through the speaker 109. Meanwhile the display unit 110 displays the text and the image information. The speech database 111 is also established in a memory unit, such as rewritable memory or a memory card, and stores correspondent speech information of texts.

Through the aforesaid construction, the personal digital assistant 10 is capable of playing speech of electronic books. The speech database 111 stores a lot of speech information that is correspondent to text components. For example, the correspondent speech information of each word is stored. The memory unit 107 stores text information of electronic books. The text information may also be downloaded from a network connected through the network interface 102 and the network connector 103, or via the wireless transceiver 104 and the antenna 105. The memory unit 107 also stores a software program for operating the process of the invention. When the central processing unit 106 executes the software program, it retrieves the text information stored in the memory unit 107, processes it into speech information according to the speech database 11, and transfers it to the speech microchip 108. Then, the speech microchip 108 transforms the speech information into analog signal and produces speech through the speaker 109.

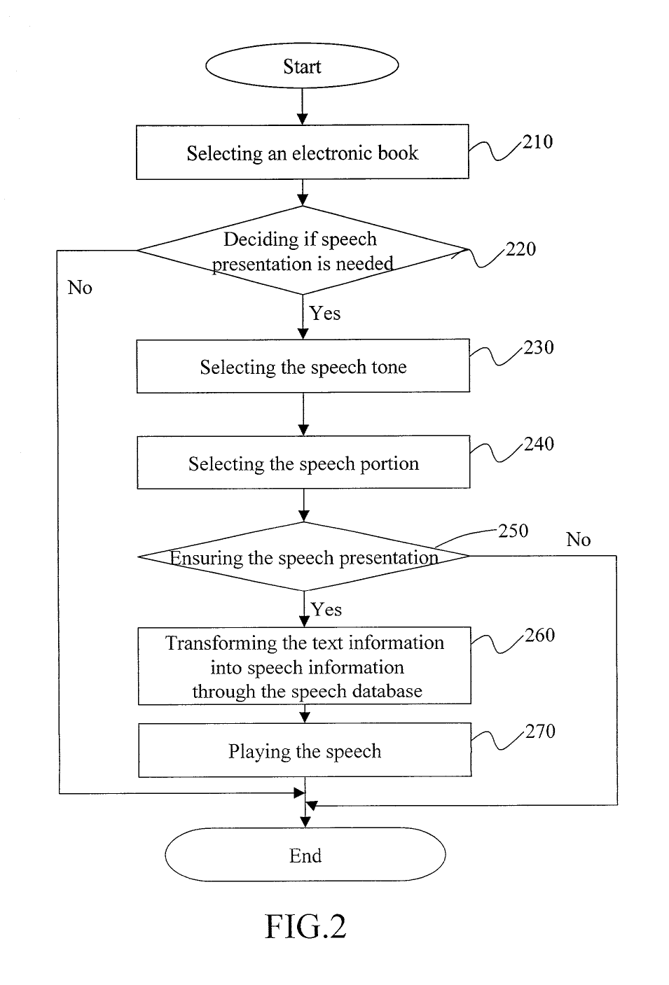

The detailed process of the invention is illustrated in FIG. 2. In this embodiment, the text information of an electronic book is stored in the memory unit of the PDA or in the memory card that is mounted to the PDA. In other words, the electronic book is equipped with the information-processing apparatus. The process of operation includes the following steps. First, selecting an electronic book (step 210). Then, deciding if speech presentation is needed (step 220). If yes, selecting the speech tone (step 230) and the portion for speech (step 240). Ensuring the speech presentation (step 250). Then, transforming the text information into speech information through the speech database (step 260) and playing the speech (step 270).

Also referring to FIG. 1, when starting, the display unit 110 shows titles of electronic books for user to choose. After an electronic book is chosen (step 210), the display unit 110 shows a message like “Do you want the speech mode?” (step 220). The message can be a text message or a speech message. The user may decide “yes” by pressing a certain key to start further processes, or decide “no” by pressing another key to stop the process. To start the speech process, a certain speech tone, for example a male voice or a female voice can be chosen (step 230). Then, the display unit 110 shows the sections of the electronic book for the user to choose whether playing entire book or a part of it (step 240). After the range is selected, the display unit 110 shows a message for the user to make sure the speech presentation (step 250). After ensuring by pressing a certain key, the text information is transformed into speech information (step 260) and the speech is played (step 270). Otherwise, the user presses another key to stop the process.

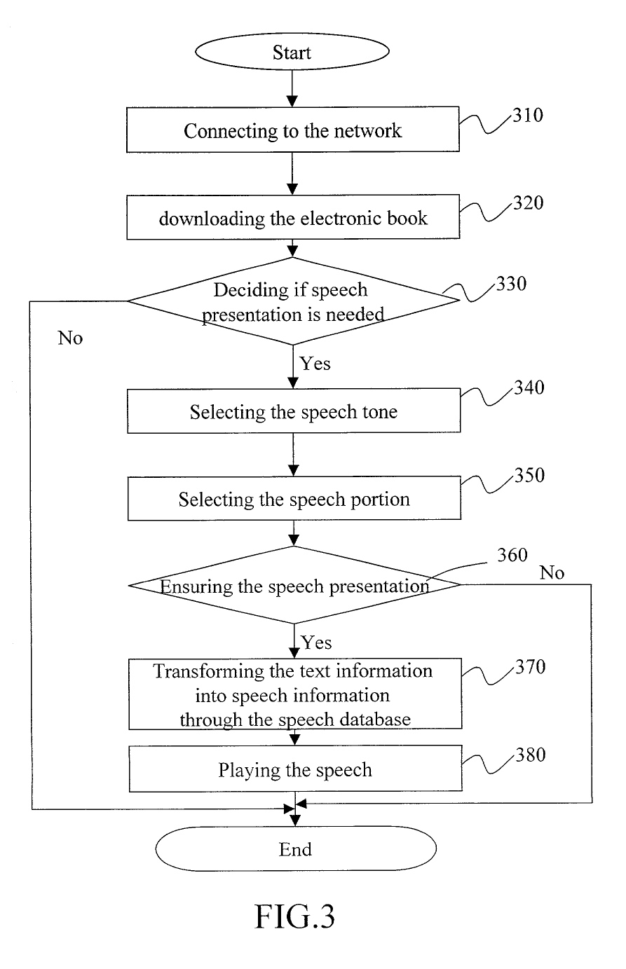

Another embodiment of the invention is illustrated in FIG. 3 in which the text information of an electronic book is online accessible form a network. The process of operation includes the following steps. First, connecting to the network (step 310). Then, downloading the electronic book (step 320). Deciding if speech presentation is needed (step 330). If yes, selecting the speech tone (step 340) and the portion for speech (step 350). Ensuring the speech presentation (step 360). Then, transforming the text information into speech information through the speech database (step 370) and playing the speech (step 380).

The difference between the processes of FIG. 3 and FIG. 2 is only the storage site of the electronic book. In FIG. 3, the electronic book is stored on a network site, therefore, the step 310 of network connection is required. By network access, the capacity of the memory unit 107 can be decreased, and the categories of information can be increased. In the downloading process of step 320, paragraph contents can first be download. Then, after a certain portion is decided (steps 350, 360), the text information can be downloaded and processed into speech, as shown in steps 370 and 380. The speech-playing can be operated by a personal digital assistant 10 as illustrated in FIG. 1 and described above.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for presenting text information with speech utilizing an information-processing apparatus having a speech database and a memory for storing text information, for presenting said text information with speech, comprising the steps of:
selecting said text information;
inputting a speech-playing command;
instructing a user to choose a portion of said text information for speech;
selecting said designated text portion and transforming into speech information by means of said speech database; and
outputting speech with said speech information.

2. The method of claim 1, wherein said information-processing apparatus is selected from the group consisting of personal digital assistants, mobile communication devices, and portable computers.

3. The method of claim 1, wherein said text information is of electronic books.

4. The method of claim 1, wherein said step of inputting a speech-playing command is operated by a user through an input unit.

5. The method of claim 1, wherein said step of inputting a speech-playing command comprises a step of selecting a starting command.

6. The method of claim 5, wherein said starting command is selected from the group consisting of texts and speech.

7. The method of claim 1, wherein said step of inputting a speech-playing command further comprises a step of selecting a speech tone.

8. A method for presenting text information with speech utilizing an information-processing apparatus having a speech database and a memory for receiving text information from a network, for presenting said text information with speech, comprising steps of:
connecting with said network for access of said text information;
downloading and storing said text information into said memory;
inputting a speech-playing command;
instructing a user to choose a portion of said text information for speech;
selecting said designated text portion and transforming into speech information by means of said speech database; and
outputting speech with said speech information.

9. The method of claim 8, wherein said step of downloading and storing said text information into said memory also finishes said step of inputting a speech-playing command.

10. The method of claim 8, wherein said step of inputting a speech-playing command is operated by a user through an input unit.

11. The method of claim 8, wherein said step of inputting a speech-playing command comprises a step of selecting a starting command.

12. The method of claim 11, wherein said starting command is selected from the group consisting of texts and speech.

13. The method of claim 8, wherein said step of inputting a speech-playing command further comprises a step of selecting a speech tone.

14. A method for presenting text information with speech utilizing a personal digital assistant having a speech database and a memory for receiving text information from a network, for presenting said text information with speech, comprising steps of:
connecting with said network for access of said text information;
downloading and storing said text information into said memory;
inputting a speech-playing command;
instructing a user to choose a portion of said text information for speech;
selecting said designated text portion and transforming into speech information by means of said speech database; and
outputting speech with said speech information.

15. The method of claim 8, wherein said step of downloading and storing said text information into said memory also finishes said step of inputting a speech-playing command.

16. The method of claim 14, wherein said step of inputting a speech-playing command is operated by a user through an input unit.

17. The method of claim 14, wherein said step of inputting a speech-playing command comprises a step of selecting a starting command.

18. The method of claim 17, wherein said starting command is selected from the group consisting of texts and speech.

19. The method of claim 14, wherein said step of inputting a speech-playing command further comprises a step of selecting a speech tone.

20. The method of claim 19, wherein said speech tone comprises female voice and male voice.
